(19) United States
(12) Patent Application Publication
(10) Pub. No.: US 2019/0379055 A1
(43) Pub. Date: Dec. 12, 2019

(54) Battery Paste and Electrolyte Compositions and Electrochemical Cell for Use Therewith

(71) Applicant: CPS Technology Holdings LLC, New York, NY (US)

(72) Inventors: Deepan Chakkaravarthi Bose, Milwaukee, WI (US); Jose Gabriel Rincon Calzada, Monterrey (MX); Reyes Santos Alvarez Varela, Guadalupe (MX)

(21) Appl. No.: 16/481,247

(22) PCT Filed: Jan. 26, 2018
(86) PCT No.: PCT/US18/15422

§ 371 Date: Jul. 26, 2019

Related U.S. Application Data
(60) Provisional application No. 62/454,305, filed on Feb. 3, 2017.
(60) Provisional application No. 62/451,523, filed on Jan. 27, 2017.

(51) Int. Cl. H01M 4/62; H01M 10/10; H01M 4/20; H01M 4/68

(52) U.S. Cl. CPC H01M 4/627; H01M 10/10; H01M 2300/0008; H01M 4/68; H01M 4/20

(57) ABSTRACT

A lead acid battery is provided. The battery includes a container and a plurality of electrochemical cells within the container. The electrochemical cells have a plurality of flat positive plates each composed of a grid formed of virgin lead or high purity lead or highly purified secondary lead and a positive battery paste disposed on the grid, the battery paste comprising a lead-containing composition, a positive plate paste vehicle, and a polyvinylsulfonate additive. The electrochemical cells also have a plurality of flat negative plates each composed of a grid and a negative battery paste disposed on the grid, the battery paste comprising a lead-containing composition and a negative plate paste vehicle. An absorbent glass mat is interleaved between the flat positive plate and the flat negative plate. An electrolyte is provided in the container and retained in the absorbent glass mat. The electrolyte includes phosphoric acid. The plurality of flat positive plates and the plurality of flat negative plates are connected by intercell connectors and coupled to one or more terminals. A lid is provided on the container.

### CROSS-REFERENCE TO RELATED APPLICATIONS

This application claims priority to U.S. Provisional Patent Application, Ser. No. 62/451,523, filed Jan. 27, 2017, entitled BATTERY PASTE AND ELECTROLYTE COMPOSITIONS AND ELECTROCHEMICAL CELL FOR USE THEREWITH; this application also claims priority to U.S. Provisional Patent Application, Ser. No. 62/454,305, filed Feb. 3, 2017, entitled BATTERY PASTE AND ELECTROLYTE COMPOSITIONS AND ELECTROCHEMICAL CELL FOR USE THEREWITH, the entire contents of each of which are hereby incorporated by reference herein in their entirety.

### FIELD

The invention(s) described herein relate to the field of battery paste and electrolyte compositions. More specifically the invention(s) described herein relate to an AGM lead acid battery having said battery paste and electrolyte compositions

### BACKGROUND

Lead acid batteries are known and arc often used for starting-lighting-ignition (SLI) functions as well as deep cycle (DC) related applications. Conventionally, lead acid batteries include electrically conductive positive and negative current collectors in the form of lead or lead-alloy grids. These current collectors or grids have a paste composition deposited thereon, with the makeup or composition of the paste potentially varying based upon the make-up of the current collector (e.g., a negative paste on a negative grid and a positive paste on a positive grid). Lead acid batteries also include an electrolyte which is normally acidic in nature and commonly is or includes aqueous solutions of H₂SO₄. Lead acid batteries may also include a separator between grids and/or an absorbent glass mat (AGM) wrapped around one or more said grids.

A need exists for an electrochemical cell which provides improved performance in a flat plate AGM lead acid battery.

### SUMMARY

Battery paste and electrolyte compositions are disclosed, as well as an electrochemical cell for use therewith, the combination of which provides improved performance in a flat, plate AGM lead acid battery.

An electrochemical cell is disclosed. The electrochemical cell includes a flat positive plate composed of a grid formed of virgin lead or high purity lead or highly purified secondary lead and a positive battery paste disposed on the grid. The battery paste comprises a lead-containing composition, a positive plate paste vehicle, and a polyvinylsulfonate additive. A flat negative plate is also provided which is composed of a grid and a negative battery paste disposed on the grid. The battery paste comprises a lead-containing composition and a negative plate paste vehicle. An absorbent glass mat is interleaved, between the flat positive plate and the flat negative plate and an electrolyte is provided in the container and retained in the absorbent glass mat. The electrolyte includes phosphoric acid.

A lead acid battery is also disclosed. The battery includes a container and a plurality of electrochemical cells within the container. The electrochemical cells have a plurality of flat positive plates each composed of a grid formed of virgin lead or high purity lead or highly purified secondary lead and a positive battery paste disposed on the grid, the battery paste comprising a lead-containing composition, a positive plate paste vehicle, and a polyvinylsulfonate additive. The electrochemical cells also have a plurality of flat negative plates each composed of a grid and a negative battery paste disposed on the grid, the battery paste comprising a lead-containing composition and a negative plate paste vehicle. An absorbent glass mat is interleaved between the flat positive plate and the flat negative plate. An electrolyte is provided in the container and retained in the absorbent glass mat. The electrolyte includes phosphoric acid. The plurality of flat positive plates and the plurality of flat negative plates are connected by intercell connectors and coupled to one or more terminals. A lid is provided on the container.

An additional lead acid battery is disclosed including a container and a plurality of electrochemical cells within the container. The electrochemical cells include a plurality of flat positive plates each composed of a grid formed of virgin lead or high purity lead or highly purified secondary lead and a positive battery paste disposed on the grid. The battery paste comprises a lead-containing composition, a positive plate paste vehicle, and a polyvinylsulfonate additive. The battery also includes a plurality of flat negative plates each composed of a grid and a negative battery paste disposed on the grid. The battery paste comprises a lead-containing composition, a negative plate paste vehicle, an expander, and a polyvinylsulfonate additive. An absorbent glass mat is interleaved between the flat positive plate and the flat negative plate. An electrolyte is provided in the container and retained in the absorbent glass mat. The electrolyte includes phosphoric acid, water, sulfuric acid, and sodium sulfate. The plurality of flat positive plates and the plurality of flat negative plates are connected by intercell connectors and coupled to one or more terminals. A lid is provided on the container.

These and other features and advantages of devices, systems, and methods according to this invention are described in, or are apparent from, the following detailed descriptions of various examples of embodiments.

### BRIEF DESCRIPTION OF DRAWINGS

Various examples of embodiments of the systems, devices, and methods according to this invention will be described in detail, with reference to the following figures, wherein:

FIG. 1 is a perspective, partially cut-away exploded view of one or more examples of a lead acid battery and electrochemical cell as described herein.

FIG. 2 is a front elevation, cut-away view of one or more examples of a plate for the battery or electrochemical cell of FIG. 1.

FIG. 3 is a partial cross-sectional view of the plate shown in FIG. 2, taken along line B-B of FIG. 2.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

An improved electrochemical cell having a battery paste composition and electrolyte composition is described. More specifically, a flat plate AGM lead acid electrochemical cell for a battery having an improved paste composition and an electrolyte composition is described.

The electrochemical reaction that takes place within the electrochemical cell may be, in part, the result of the reaction of the various chemical compositions therein, including for example, the grid material, the battery paste composition, and the electrolyte. Various chemical compositions are further detailed herein as used in a flat plate AGM lead acid electrochemical cell and battery.

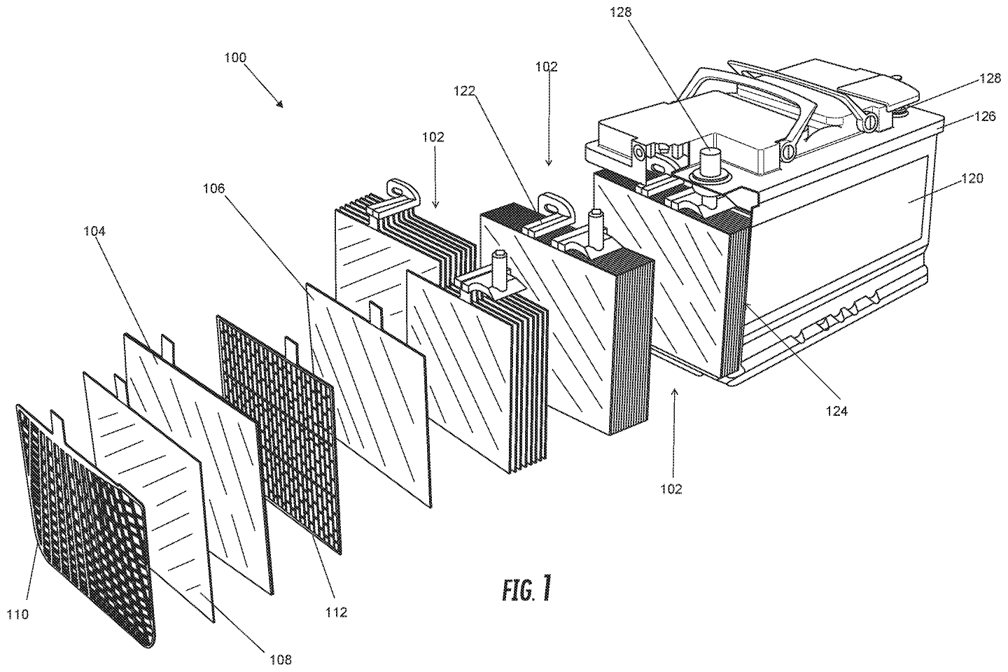

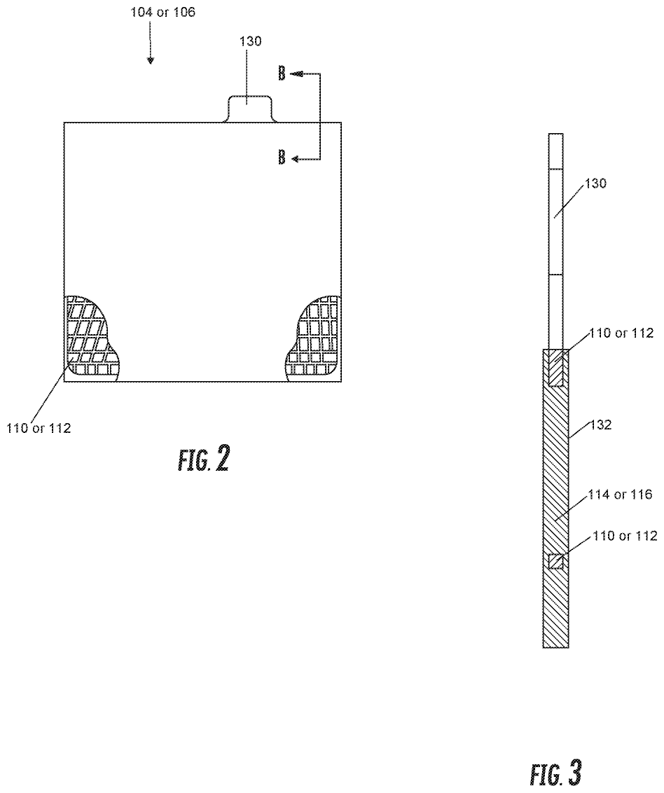

Generally, a battery 100 or electrochemical cell 102 is provided and shown in FIG. 1. The battery 100 is an AGM battery having positive and negative plates 104, 106 which are separated by an absorbent glass mat 108 that absorbs and holds the battery's acid or electrolyte and prevents it from flowing freely inside the battery. Referring to FIGS. 1-3, the plates 104, 106 include electrically-conductive positive or negative grids 110, 112 or current collecting members. Positive paste 114 is provided on the positive grid 110 and negative paste 116 is provided on the negative grid 112. More specifically, the positive plate 104 includes a positive grid 110 having or supporting a positive active material or paste 114 thereon, and in some examples of embodiments may include a pasting paper or a scrim 132; and the negative plate 106 includes a negative grid 112 having or supporting a negative active material or paste 116 thereon, and in some examples of embodiments may include a pasting paper or a scrim 132. The grids 110 and/or 112 are, in, one or more examples of embodiments, formed of pure or virgin lead or high purity lead or highly purified secondary lead. Positioned, between the positive and negative plates 114, 116 is a separator 108. In a retained electrolyte-type battery system such as described herein, the separator 108 may be a porous and absorbent glass mat (AGM). In some examples, the AGM 108 may also be used with an additional separator. As indicated, a pasting paper or pasting material or scrim 132 may also be used or provided on the plate to help retain the paste on the grid.

Individual battery cells or electrochemical cells 102 may be assembled by alternating one or more, and preferably a plurality of positive and negative plates 104, 106 and separators 108 to form a plate block 118. Each plate block 118 is positioned within a housing or container 120 of a battery 100 and connected by electrical connecting straps or intercell connectors 122 (e.g., cast on straps) to and between the cells 102. The intercell connectors 122 are connected to lugs 130 which extend from the grids 110, 112. Electrolyte 124 is included in the housing 120 and more specifically may be retained at least in part within the separator or AGM 108. A lid 126 covers the housing or container 120. In an AGM battery, the lid 126 may be sealed to the container 120.

One or more positive and one or more negative terminals 128 may be provided. Such terminals typically include portions which may extend through the cover 126 and/or housing 120 and electrically couple to the intercell connectors 122 or electrochemical cells 102, depending upon the battery design. It will be recognized that a variety of terminal arrangements are possible, including top, side or corner configurations known in the art.

According to one or more examples of embodiments, the plate (both positive and negative) 104, 106, which includes the grid or current collector 110 or 112, is a generally flat plate. Preferably, the grid or current collector (including both positive and negative) 110, 112 may be composed of lead which is virgin lead (Pb) (i.e., from a mine rather than recycled lead), or high purity lead, or highly purified secondary lead, or may be substantially pure or virgin lead. In one example, the lead may also include a small amount of tin (Sn) added to the lead which may provide improved fluidity of the metal and some corrosion resistance. According to one or more examples of embodiments, the lead may be approximately 99.9% lead. In one or more further examples of embodiments, tin in the range of approximately 0.1% to approximately 1.5% may be added to the lead.

A battery paste 114, 116 composition is provided on or supported by the one or more battery grids or current collectors 110, 112. In one or more examples, the paste 114 or 116 may be provided in a layer of a predetermined amount on the battery grid 110 or 112. An example of a suitable battery paste composition is disclosed in U.S. Pat. No. 5,871,862 which is hereby incorporated by reference herein in its entirety. Generally, as described herein the battery paste composition comprises a positive paste 114 on the positive grid 110 or current collecting member (which forms the positive plate 104) and a negative paste 116 on the negative grid 112 or current collecting member (which forms the negative plate 106). To this end, the paste according to one or more examples of embodiments may be composed of virgin lead (Pb) (i.e., from a mine rather than recycled lead), or high purity lead, or highly purified secondary lead, or substantially pure or virgin lead. In one or more examples of embodiments, the lead may be approximately 99.9% to 99.99% lead. The paste composition(s) (e.g. the positive paste, the negative paste, or both pastes) may contain a specialized paste additive.

In more detail, the positive plate 104 contains a metal (e.g., lead) grid 110 with lead dioxide active material or paste 114 thereon. More specifically, the positive paste 114 disclosed herein generally includes at least one particulate lead-containing composition and a paste vehicle. Different materials may be used in connection with the lead-containing composition, with the present invention not being restricted to any particular materials or mixtures. The selected lead-containing composition or compositions may have a particle size of about 0.1-10 microns in a representative and non-limiting embodiment. One or more examples of lead-containing compositions which may be employed in the positive paste include, but are not limited to, finely-divided elemental Pb, PbO (“litharge” or “massicot”), PbSO₄ (“red lead”), PbSO₄ (“lead sulfate” with the term “PbSO₄” being defined to also include its associated hydrates), and mixtures thereof. These materials may be employed alone or in combination as determined by numerous factors, including for example, the intended use of the battery and the other materials employed in the battery. Accordingly, the term “lead-containing composition” is defined to encompass elemental lead, lead compounds, and mixtures thereof. The positive paste 114 also includes a paste vehicle which is primarily used as a carrier medium to produce the completed paste, in one or more examples of embodiments, water may be used as the paste vehicle. A representative positive paste 114 may include about 3-25% by weight vehicle therein. In addition, the positive paste 114 may likewise contain an aqueous solution of H₂SO₄ therein (e.g., about 0.01-18M) as an optional ingredient. However, variations on the materials included in the positive paste and/or any particular amounts/concentrations of this material may not depart from the overall scope of the present invention.

As previously indicated, a specialized paste additive may be provided in at least one of the positive paste 114, the negative paste 116, or both pastes. This additive involves a polymeric composition, such as “polyvinylsulfonic acid” or the salts of this material (e.g. “polyvinylsulfonates”). For example, polyvinylsulfonic acid may be chemically characterized in accordance with the following representative formula:

(CH₂[CH SO₃ H]ₓH₁₋ₓ)ₙ

In this formula, x=0.01-1 and n=10-1000 in a preferred and non-limiting example of embodiments, with the term “polyvinylsulfonic acid” being defined to encompass all of the formulations included within these ranges. Likewise, the salts of polyvinylsulfonic acid (e.g. “polyvinylsulfonates”) may be represented by the following formula:

(CH₂[CH SO₃M]ₓH₁₋ₓ)ₙ

In the above-listed formula, M is an alkali metal or alkaline earth metal counter-ion preferably selected from the group consisting of Na⁺, K⁺, Li⁺, Ba⁺², Mg⁺², Ca⁺², and Sri⁺². Likewise, as noted above, x=0.01-1 and n=10-1000 in a preferred and non-limiting example of embodiments, with the term “polyvinylsulfonate” being defined to encompass all of the formulations included within these ranges.

Polyvinylsulfonic acid and polyvinylsulfonates are available from a number of commercial sources (listed below), and are generally classified as “water-soluble ionomers” (e.g. polymers with ionic groups). Likewise, these materials are also broadly characterized as “polyelectrolytes” with an average molecular weight in a non-limiting, representative embodiment of about 500-100,000. Polyvinylsulfonic acid and salts thereof (polyvinylsulfonates) are commercially available from many sources including but not limited to the Hoechst Company of Germany, Air Products Company of Allentown, Pa. (USA) and Nalco/Exxon of England (UK).

Polyvinylsulfonic acid and polyvinylsulfonates collectively provide numerous advantages when used in the paste compositions on the positive and/or negative current collecting members (e.g. grids) of an electrochemical cell. These benefits include, as non-limiting examples; the ability of these materials to function as “plasticizers” in which the sulfate groups therein effectively interlink particulate materials (e.g. the lead-containing compositions) in the pastes to produce a more cohesive paste product; an improvement in the overall charge capacity of the battery; an increase in battery cycle life; the production of more homogeneous, smooth, and uniform paste products which improves the overall efficiency of the paste application process; the control of extraneous crystal growth on the plates; and/or a general improvement in plate performance under normal and adverse (e.g. low temperature) operating conditions. Moreover, use of the claimed additive in the positive (and/or negative) paste generally improves the consistency of the paste. When added to the positive paste and/or negative paste, the additive may function as a “rheology modifier” which makes the paste smoother and more adhesive, thereby facilitating the paste application process.

The completed positive paste may have a typical density of about 3-5 g/cc. One example of a positive paste 114 containing the desired additive composition is provided in Table I:

TABLE I

| Ingredient | Amount (% by weight) |
|---|---|
| Particulate lead-containing | about 70-95 |
| composition (e.g. Pb₃O₄) | |
| Paste additive (e.g. polyvinyl- | about 0.001-0.5 |
| sulfonic acid or a selected polyvinylsulfonate) | |
| Acid composition (e.g. H₂SO₄) | about 0-5 |
| Paste vehicle (e.g. water) | balance (amount |
| | needed to make 100%) |
| | Total: 100% |

The information in Table I is presented for purposes of example only and one of skill in the art will understand that variations thereon may be made without departing from the overall scope of the present invention.

It is also contemplated that the positive paste 114 may be used without the additive. For example, the positive paste may have the following representative composition values: Particulate lead-containing composition: about 70-95% by weight; H₂ SO₄: about 0-5% by weight; and Paste vehicle (water): balance needed to make 100%.

The negative plate 106 may be composed of a metal (e.g., lead) grid 112 with a spongy lead active material or paste 116 thereon. The negative paste 116 may, in a preferred embodiment, be substantially similar to the positive paste with certain exceptions as outlined below. Like the positive paste, the lead of the negative paste 116 may be a pure or virgin lead, or substantially pure or virgin lead. In this regard, the lead may be approximately 99.9% to 99.99% lead. Exemplary lead-containing compositions which may be employed in the negative paste 116 include but are not limited to finely-divided elemental Pb, PbO (“litharge” or “massicot”), Pb₃ O₄ (“red lead”), PbSO₄ (“lead sulfite” with the term “PbSO₄” being defined to also include its associated hydrates), and mixtures thereof. These materials may be employed alone or in combination as determined by numerous factors, including for example, the intended use of the battery and the other materials employed in the battery. Accordingly, the term “lead-containing composition” is defined to encompass elemental lead, lead compounds, and mixtures thereof.

If needed, the negative paste 116 may also include an optional “expander” which, for example, may be designed to promote paste uniformity and consistency, as well as long term or “cycling” performance. Representative materials suitable for this purpose include, but are not limited to, barium sulfate, carbon black, and lignosulfonate (which may consist of a non-water-soluble mononuclear phenylpropane derivative) and the like.

The completed negative paste 116 may have a typical density of about 3-5 g/cc. One example of a negative paste 116 containing the desired additive composition is provided in Table II:

TABLE II

| Ingredient | Amount (% by weight) |
|---|---|
| Particulate lead containing | about 70-95 |
| composition (e.g. Pb₃O₄) | |
| Paste additive (e.g. polyvinyl- | about 0.001-0.5 |
| sulfonic acid or a selected polyvinylsulfonate) | |
| Acid composition (e.g. H₂SO₄) | about 0-5 |
| Expander (e.g. barium sulfate) | about 0-5 |
| Paste vehicle (e.g. water) | balance (amount |
| | needed to make 100%) |
| | Total: 100% |

The information in Table II is presented for purposes of example only and one of skill in the art will understand that variations thereon may be made without departing from the overall scope of the present invention.

It is also contemplated that the claimed additive may be absent from the negative paste and only present in the positive paste. To this end, the negative paste 116 without the additive may have the following example composition values: Particulate lead-containing composition; about 70-95% by weight; H₂ SO₄: about 0-5% by weight; Expander: about 0-5% by weight; and Paste vehicle (water): balance needed to make 100%.

As indicated, an electrolyte 124 is also provided in the battery 100. Generally, the electrolyte 124 may be a solution which is clear, colorless and free of particulate matter. The electrolyte 124 in one or more particular examples of embodiments may be composed of phosphoric acid which may be added to sulfuric acid and water. The electrolyte 124 according to one or more further examples of embodiments may be composed of phosphoric acid and/or sodium sulfate which are added to sulfuric acid and water. It is also contemplated that no phosphoric acid may be present in the electrolyte 124. Preferably, the electrolyte 124 is composed of water, which may be deionized water, sulfuric acid, phosphoric acid, and sodium sulfate, and in some instances may include one or more impurities.

A variety of quantities or concentrations of the respective components may be used which are suitable for the intended purposes of the battery or for manufacturing purposes. For example, phosphoric acid may be present in the electrolyte 124 in a variety of concentrations and ranges thereof. As non-limiting examples, the phosphoric acid may be present in a range of from approximately 0.05 g/L to approximately 5.0 g/L, and/or may range from approximately 0.3 to approximately 3 g/L, and/or may range from approximately 0.1 g/L to approximately 0.5 g/L, and/or may range from approximately 1 g/L to approximately 2 g/L.

Various impurities, such as metal ions, may also be present. Examples of impurities may include, but are not limited to, Ag, As, Bi, Cd, Co, Cr, Cu, Fe, Mn, Mo, Ni, Pt, Sb, Se, Te, V, Zn, Chloride, TOC. Generally, in sonic examples the metal ions may not exceed a total concentration.

As indicated, the foregoing information is presented for purposes of example only and one of skill in the art will understand that variations thereon may be made without departing from the overall scope of the present invention.

An electrolyte 124 as described above and used in association with a fiat plate electrochemical cell 102 is unique to the present invention. More specifically, a unique flat plate AGM electrochemical cell 102 is described having a phosphoric acid in the electrolyte solution, and/or a phosphoric acid and sodium sulfate in the electrolyte solution. Such a combination has various advantages, including, for example improved performance of the electrochemical cell.

In one or more examples of embodiments, the electrochemical cell 102 is or includes an absorbent glass mat or AGM 108. The mat or AGM 108 may be formed of any commercially known or future developed material and generally comprises a woven or non-woven mat of fibers composed of polymer and/or glass, such as but not limited to very fine fiberglass. Electrolyte 124 may be, in part, absorbed by the mat 108 between the plates 104, 106 and immobilized by the mat 108, while keeping the electrolyte 124 available to the plates 104, 106, thereby allowing a fast reaction between the electrolyte 124 and plate material. To this end, the positive and negative plates 104, 106 may be separated by an absorbent glass mat 108 that absorbs and holds the electrolyte 124. The saturation ratio of the electrolyte 124 in the mat 108 is improved over existing devices.

A battery 100 having one or more electrochemical cells 102 of the type described herein is shown in FIG. 1. According to one or more examples of embodiments, the battery 100 is a lead acid storage battery. According to one or more further examples of embodiments, the lead acid storage battery 100 is a sealed lead acid battery or an AGM lead acid battery. While specific examples are described and illustrated, any secondary battery having the characteristics described herein may be acceptable for the purposes provided. The battery 100 in one or more examples of embodiments is configured to provide at least a portion of the power required to start or operate a vehicle and/or various vehicle systems. Further, it should be understood that the battery 100 may be utilized in a variety of applications not involving a vehicle, and all such applications are intended to be within the scope of the present disclosure.

As indicated, the battery 100 includes several electrochemical cells 102 which are provided in separate compartments of a container or housing 120. The plurality of electrochemical cells 102 are electrically connected by intercell connectors 122 and terminals 128 are provided which are electrically connected to the cells 102 and which may extend through the lid 126 or container 120. To this end, a cover or lid 126 is provided on the container 120, and may be sealed thereto. In various embodiments, the lid 126 and/or container 120 includes terminal bushings, fill tubes, vent openings, and the like, as is customary for AGM batteries.

One or more examples of production of an electrochemical cell 102 having the foregoing components will now be described. As indicated, production of a battery 100 or electrochemical cell 102 includes obtaining electrically-conductive positive and negative grids 110, 112 or current collecting members. Either or both the positive arid negative grids 110, 112 are, in one or more examples of embodiments, formed of virgin lead or high purity lead or highly purified secondary lead. Using conventional paste application techniques, the positive paste 114 is applied to the positive current collecting member 110 on both sides thereof (and within the openings in the grid or current collecting member). In a similar manner, the negative paste 116 is applied to the negative current collecting member 112 on both sides thereof (and within the openings in the grid or current collecting member).

Once the positive and negative current collecting members 110, 112 are pasted in order to form the positive plate 104 and the negative plate 106, individual cells 102 may be assembled. To this end, one or more, and preferably a plurality of positive and negative plates 104, 106 are stacked together in an alternating manner, with a separator 108 positioned or interleaved between them or wrapped around one of said plates. In a retained electrolyte-type battery system such as disclosed herein, the separator 108 may be a porous and absorbent mat (AGM) that is interleaved with the plates 104, 106 or wrapped around at least a portion of one of the plates. A pasting paper or pasting material or scrim 132 may also be used, placed upon the plate 104 or 106 between the plate and the mat 108 to help retain the paste 114 or 116 on the grid 110 or 112. Plate blocks 118 are formed by assembling a grouping of a plurality of positive and negative plates 104, 106 in the manner described.

The plate blocks 118 are then positioned within the housing or container 120, followed by connection of the electrical connecting straps or intercell connectors 122 (e.g., cast on straps) to and between the cells 102 and in particular to the respective lugs 130 on the grids; and electrolyte 124 addition (which may be retained within the separator member). The electrolyte solution is provided in the housing or container 120 between the electrode plates 104, 106 (e.g., absorbed within the separator mat 108). The lid 126 is then secured to the housing or container 120 followed by “formation” of the battery.

While a specific order of events is described for purposes of example, the invention is not limited thereto and variations in the order of events may be acceptable for the purposes provided.

As set forth above, an AGM battery having the foregoing chemical compositions provided in association with a flat plate electrochemical cell provides improved performance over existing devices.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

The technical, effects and technical problems in the specification are exemplary and are not limiting. It should be noted that the embodiments described in the specification may have other technical effects and can solve other technical problems.

1. An electrochemical cell comprising:
a flat positive plate composed of a grid formed of virgin lead or high purity lead or highly purified secondary lead and a positive battery paste disposed on the grid, the battery paste comprising a lead-containing composition, a positive plate paste vehicle, and a polyvinylsulfonate additive
a flat negative plate composed of a grid, and a negative battery paste disposed on the grid, the battery paste comprising a lead-containing composition and a negative plate paste vehicle;
an absorbent glass mat interleaved between the flat positive plate and the flat negative plate; and
an electrolyte in the container and retained in the absorbent glass mat, the electrolyte including phosphoric acid.

2. The electrochemical cell of claim 1, wherein the electrolyte further comprises sodium sulfate.

3. The electrochemical cell of claim 1, wherein the electrolyte further comprises water, sulfuric acid, and sodium sulfate.

4. The electrochemical cell of claim 1, wherein the polyvinylsulfonate additive comprises polyvinylsulfonic acid or salts of this material.

5. The electrochemical cell of claim 1, wherein the negative paste further comprises a polyvinylsulfonate additive.

6. The electrochemical cell of claim 1, wherein the negative paste further comprises an expander.

7. The electrochemical cell of claim 1, wherein the positive plate paste vehicle is water.

8. The electrochemical cell of claim 1, wherein the negative plate paste vehicle is water.

9. The electrochemical cell of claim 1, wherein the phosphoric acid is present in a range of from approximately 0.05 g/L to approximately 5.0 g/L.

10. The electrochemical cell of claim 1, wherein the negative plate is composed of virgin lead or high purity lead or highly purified secondary lead.

11. The electrochemical cell of claim 1, wherein the lead-containing composition of the positive plate comprises virgin lead or high purity lead or highly purified secondary lead in the range of 99.9% to 99.99% lead.

12. The electrochemical cell of claim 1, wherein the lead-containing composition of the negative plate comprises virgin lead or high purity lead or highly purified secondary lead in the range of 99.9% to 99.99% lead.

13. A lead acid battery comprising:
a container;
a plurality of electrochemical cells within the container, the electrochemical cells comprising:
a plurality of flat positive plates each composed of a grid formed of virgin lead or high purity lead or highly purified secondary lead and a positive battery paste disposed on the grid, the battery paste comprising a lead-containing composition, a positive plate paste vehicle, and a polyvinylsulfonate additive;
a plurality of flat negative plates each composed of a grid and a negative battery paste disposed on the grid, the battery paste comprising a lead-containing composition and a negative plate paste vehicle;
an absorbent glass mat interleaved between the flat positive plate and the flat negative plate; and
an electrolyte in the container and retained in the absorbent glass mat, the electrolyte including phosphoric acid;
the plurality of flat positive plates and the plurality of flat negative. plates being connected by intercell connectors and coupled to one or more terminals; and
a lid on the container.

14. The lead acid battery of claim 13, wherein the electrolyte further comprises sodium sulfate.

15. The lead acid battery of claim 13, wherein the positive paste further comprises a polyvinylsulfonate additive.

16. The lead acid battery of claim 13, wherein the negative paste further comprises an expander.

17. The lead acid battery of claim 13, wherein the positive plate paste vehicle is water.

18. The lead acid battery of claim 13, wherein the negative plate paste vehicle is water.

19. A lead acid battery comprising:
a container;
a plurality of electrochemical cells within the container, the electrochemical cells comprising:
a plurality of flat positive plates each composed of a grid formed of virgin lead or high purity lead or highly purified secondary lead and a positive battery paste disposed on the grid, the battery paste comprising a lead-containing composition, a positive plate paste vehicle, and a polyvinylsulfonate additive;
a plurality of flat negative plates each Composed of a grid and a negative battery paste disposed on the grid, the battery paste comprising a lead-containing composition, a negative plate paste vehicle, an expander, and a polyvinylsulfonate additive;
an absorbent glass mat interleaved between the flat positive plate and the flat negative plate; and
an electrolyte in the container and, retained in the absorbent glass mat, the electrolyte including phosphoric acid, water, sulfuric acid, and sodium sulfate;
the plurality of flat positive plates and the plurality of flat negative plates being connected by intercell connectors and coupled to one or more terminals; and
a lid on the container.

20. The lead acid battery of claim 19, wherein the polyvinylsulfonate additive comprises polyvinylsulfonic acid or salts of this material.
